(19) United States
(12) Patent Application Publication
(10) Pub. No.: US 2012/0186373 A1
(43) Pub. Date: Jul. 26, 2012

(54) Rack-Type Steering Gear

(76) Inventors: Michael Georg Figura, Dormagen (DE); Torsten Kluge, Overath (DE)

(21) Appl. No.: 13/356,732

(22) Filed: Jan. 24, 2012

(30) Foreign Application Priority Data
Jan. 26, 2011 (DE) 102011003180.4

(51) Int. Cl. B62D 3/12

(52) U.S. Cl. 74/89.17

(57) ABSTRACT

A rack-type steering gear (1) comprising a steering gear housing (2), a pinion (3) connected non-rotatably to a steering shaft and mounted rotatably in the steering gear housing (2), and a rack (5) mounted axially displaceably in the steering gear housing (2) is described, the toothing of the pinion (3) engaging with the toothing of the rack (5). The pinion (3) can be preloaded against the rack (5) and the rack (5) is mounted in the steering gear housing (2) by means of linear rolling bearings.

The present invention relates to a rack-type steering gear, in particular for motor vehicles, according to the preamble of claim 1, comprising a steering gear housing, a pinion connected non-rotatably to a steering shaft and mounted rotatably in the steering gear housing, and a rack mounted axially displaceably in the steering gear housing, the toothing of the pinion engaging with the toothing of the rack.

Such rack-type steering gears are used in known fashion to transmit the rotary motion of a steering wheel, which is connected non-rotatably, for example via a steering shaft, to the pinion of the rack-type steering gear, to the rack of the rack-type steering gear, which rack is consequently displaced axially and swivels one or more wheels of a motor vehicle by means of a steering linkage which is connected to one or more wheel carriers.

Especially in the case of electrically and/or hydraulically driven power-assisted steering systems, very large turning moments have in some cases to be transmitted between the pinion and the rack by the rack-type steering gear. The turning moments to be transmitted between pinion and rack usually increase with increasing steering angle, that is, with increasing axial displacement of the rack from the center position in the direction of the axial end positions of the rack. Large radial forces corresponding to the turning moment to be transmitted can arise in the meshing of pinion and rack, which forces can lead to separation of the pinion from the rack. Furthermore, shock loadings in the steering system also give rise to large radial forces in the meshing of pinion and rack. In order to avoid separation of pinion from rack, it is general practice to press or preload the rack against the pinion, which is mounted rigidly, axially and radially, in the steering gear housing.

For example, U.S. Pat. No. 6,119,540 describes a rack-type steering gear in which the toothing of a pinion, which is mounted rigidly, axially and radially, but rotatably, in a steering gear housing, is in engagement with the toothing of a rack which is mounted axially displaceably in the steering gear housing. The rack is preloaded by means of a pressure piece against the pinion which is mounted radially rigidly in the steering gear housing. For this purpose, two spring elements which press the pressure piece and therefore the rack against the toothing of the pinion are, in particular, provided between the pressure piece and the steering gear housing or an adjustable abutment part which can be screwed into the steering gear housing. As the respective spring elements, a conventional compression spring and an elastonneric O-ring, for example, are provided. The rack is mounted slidably on the pressure piece.

A similar rack-type steering gear is known from U.S. Pat. No. 6,435,050, in which, however, the rack is pressed against the pinion by means of a bearing ring on the rack in addition to the conventional pressure piece. The rack is mounted slidably both on the pressure piece and in the bearing ring. The aim of the invention is to minimize or suppress the tendency of the rack/pressure piece connection to rattle.

In order to prevent separation of pinion and rack by the radial forces acting in the meshing of pinion and rack, for example as a result of a shock loading or a large turning moment to be transmitted, the pressure piece according to the prior art is preloaded relatively strongly with a spring element against the pinion of the rack-type steering gear. This preloading gives rise to relatively high, non-negligible friction between the pressure piece and the rack mounted slidably thereon. However, high friction between rack and pressure piece adversely influences steering feel, especially in the straight-ahead or center position of the steering gear, since a rack-type steering gear with high internal friction imparts an undesirably imprecise steering feel.

Against this background, it is the object of the present invention to specify a rack-type steering gear which has substantially reduced internal friction without an increased tendency to rattle, and which imparts a precise steering feel.

This object is achieved by a rack-type steering gear having the features of claim 1. Further, especially advantageous configurations of the invention are disclosed in the dependent claims.

It should be pointed out that the features set forth individually in the claims can be combined with one another in any technically useful manner and indicate further configurations of the invention. The description additionally characterizes and specifies the invention in particular in conjunction with the figures.

A rack-type steering gear according to the present invention comprises a steering gear housing, a pinion connected non-rotatably to a steering shaft and mounted rotatably in the steering gear housing, and a rack which is mounted axially displaceably in the steering gear housing. The toothing of the pinion engages with the toothing of the rack in order to transmit turning moments from the pinion to the rack and vice versa. The pinion of the rack-type steering gear according to the invention is preloadable against the rack and the rack is mounted on linear rolling bearings in the steering gear housing.

Within the meaning of the present invention, “the pinion is preloadable against the rack” should be understood to mean that the pinion, when installed in the steering gear housing, is subjected to a force acting substantially in a direction in which the pinion w ould have to be moved in order to bring the toothing of the pinion into engagement with the toothing of the rack. Consequently, the preloading force presses the pinion against the rack in such a manner that the engagement of the toothings of pinion and rack is permanently ensured, even with large radial forces and shock loadings acting in the meshing.

The direction of action of the preloading force exerted on the pinion depends generally on the type and, in particular, the position of the toothings of pinion and rack with respect to one another. Thus, the preloading force may preload the pinion against the rack in substantially only a radial direction or, equally, the preloading force may act, at least partially, also in the axial direction of the pinion, for example if the pinion and the rack engage with one another via a bevel toothing.

By virtue of the pinion being preloadable against the rack according to the invention, the pressure piece provided according to the prior art, on which the rack is usually mounted slidably and with which the rack is usually pressed against the pinion, can be dispensed with. This already offers the major advantage that the rack-type steering gear according to the invention is substantially smaller and more space-saving in construction. Thus, the rack-type steering gear can also be used, for example, in tightly confined installation space, for example in small vehicles.

Furthermore, the rack of the rack-type steering gear according to the invention can be mounted on linear rolling bearings by means of a rolling bearing unit, in particular a linear rolling bearing unit. The generally significantly lower friction of a rolling bearing in comparison to a sliding bearing makes possible a low-friction, linear mounting of the rack inside the steering gear housing. This allows a free-running axial displacement of the rack. The low-friction mounting of the rack, and therefore a substantially lower internal friction of the rack-type steering gear, leads to a substantially more precise steering feel, which makes itself felt positively especially in the straight-ahead position or center position of the rack-type steering gear.

Because the internal friction of the rack-type steering gear according to the invention is substantially duced, without the need to reduce the pre o loading frce with which the pinion is pressed against the rack, and therefore the contact force between pinion and rack, the tendency of the rack-type steering gear according to the invention to rattle is advantageously not increased in comparison to a rack-type steering gear according to the prior art.

The pinion of the rack-type steering gear according to the invention which is preloadable against the rack counteracts radial forces arising in the meshing between pinion and rack and effectively prevents separation of pinion and rack, even especially in the event of shock loadings. The rack-type steering gear according to the invention is therefore also able to reliably transmit large turning moments between pinion and rack.

In addition, the pinion which is preloadable against the rack is also advantageously able to eliminate bearing play present in the mounting of pinion and/or rack, and therefore to compensate for component tolerances. In general, any tendency of the rack-type steering gear according to the invention to rattle is thereby effectively reduced or suppressed.

In an advantageous configuration of the invention, at least one rolling element track is formed in the rack and/or in the steering gear housing. This track serves to guide at least one rolling element. An especially compact construction of the rack-type steering gear according to the invention is achieved by forming the rolling element track substantially in the rack, that is, on the circumference of the rack body. In particular, the at least one rolling element track of the rack-type steering gear according to the invention is formed substantially in the section of the circumference of the rack in which the toothing of the rack is not provided, for example opposite the toothing of the rack. The rolling element runs between the rolling element track formed in the rack and the steering gear housing.

All conventional rolling elements may be used as rolling elements for mounting the rack, for example balls, barrels, cylindrical rollers, etc. One or more rolling elements may be received in a rolling element track. If a plurality of rolling elements are provided in a track, they may be surrounded by a cage which ensures a defined distance between the rolling elements.

In an advantageous configuration of the invention, a plurality of rolling element tracks are formed in the rack and/or in the steering gear housing. These may be distributed evenly around the circumference of the rack or may be provided in particular where an especially high bearing loading of the rack is to be expected. This makes possible a stable mounting of the rack, since the force acting on the rack, for example the radial force acting in the meshing between pinion and rack or the preloading force exerted by the pinion on the rack, is transmitted evenly to the steering gear housing via a plurality of rolling elements.

In an especially advantageous configuration of the invention, the pinion is preloadable elastically against the rack by means of at least one spring element. Through the elastic preloading shock loadings, in particular, can be effectively absorbed by the pinion, which loadings might possibly lead to fracture of the pinion with a rigid mounting thereof. Moreover, the elastic preloading of the pinion against the rack ensures automatic compensation of wear. Manual readjustment of the pinion/rack connection can therefore be dispensed with.

In a further advantageous configuration of the invention, the pinion can be further supported against the steering gear housing by means of at least one damping element, in particular an elastic damping element. The damping element is able, in particular, to damp jolting movements of the pinion caused by shock loadings, and therefore, in particular, effectively to counteract rattle generation by the rack-type steering gear.

According to a further advantageous configuration of the invention, the preloading force with which the pinion is pressed against the rack is adjustable by means of at least one tensioning device. The tensioning device makes possible precise adjustment of the preloading force independently of any component tolerances and bearing play that may be present in the rack-type steering gear.

In a further advantageous configuration of the invention, the pinion is mounted in the steering gear housing by means of one fixed bearing and at least one movable bearing, in such a way that the pinion can be swiveled in the radial direction. Preferred embodiments for the fixed bearing and/or the movable bearing or bearings are sliding bearings and rolling bearings respectively. The fixed bearing supports the pinion substantially rigidly in both the radial and the axial direction. The movable bearing, by contrast, has an additional degree of freedom with respect to the fixed bearing, so that the pinion is not impeded by the movable bearing in the radial direction, for example, and allos oveent of the pinion in the radial direction. This additional degree of freedom of the movable bearing allows the pinion a sufficiently large freedom of movement in the radial direction unimpeded by the movable bearing, so that the pinion can be swiveled in this direction. The pinion can therefore be moved or preloaded in this direction in order to bring the toothing of the pinion into stronger engagement with the toothing of the rack. To make possible a sufficiently large reciprocating movement of the pinion, a self-aligning bearing may be selected as the fixed bearing.

In a further configuration of the invention, the movable bearing of the pinion is advantageously spring-loaded in the radial direction by means of at least one spring element. The pinion can therefore be preloaded against the rack via the spring-loaded movable bearing. The preloading force may be determined in a simple manner by the selection of a suitable spring element, for example a helical spring or disk spring with appropriate spring properties.

A further configuration of the invention provides that the movable bearing is supported against the steering gear housing by means of at least one damping element, in particular an elastic or elastomeric damping element. Jolting movements of the movable bearing and of the pinion in a radial direction, caused in particular by shock loadings, are thereby damped, effectively counteracting rattle generation.

Further advantageous details and effects of the invention are explained in more detail below with reference to an exemplary embodiment represented in a FIGURE.

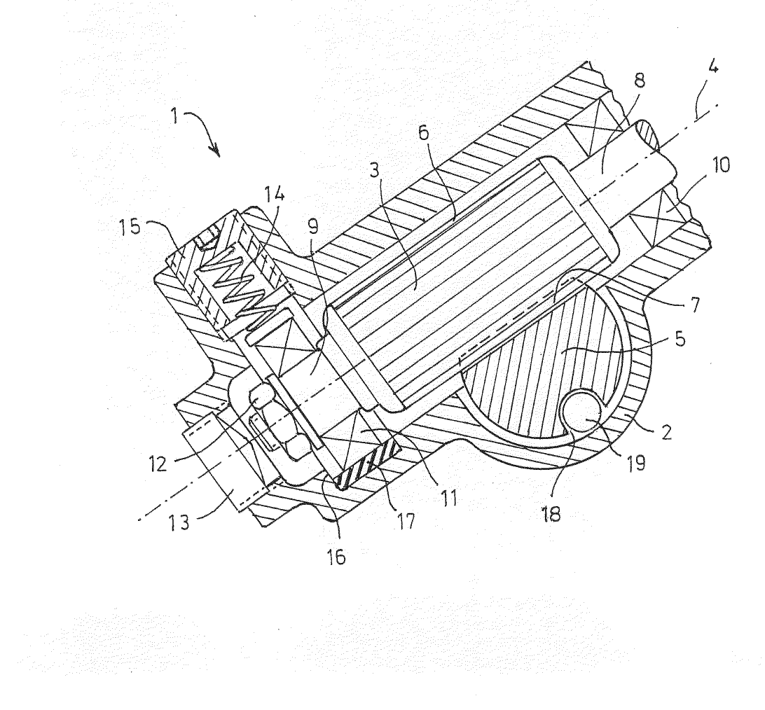

FIG. 1 is a schematic sectional view of an exemplary embodiment of the rack-type steering gear according to the invention.

The exemplary embodiment of a rack-type steering gear 1 according to the invention represented in FIG. 1 comprises a steering gear housing 2 in which a pinion 3 is mounted rotatably about an axis of rotation 4 and in which arack 5 is mounted axially displaceably. The direction of the axial displacement of the rack 5 extends perpendicularly to the drawing plane in FIG. 1.

The pinion 3 represented in FIG. 1 has a substantially cylindrical configuration and has on its outer circumference a toothing 6 which engages with a toothing 7 of the rack 5.

The pinion 3 has on its axial end sections respective upper and lower shaft extensions 8 and 9. The upper shaft extension 8 is connected non-rotatably to a steering shaft (not further represented in FIG. 1) which in turn is connected to a steering wheel (also not shown) by means of which an operator, for example a driver of a motor vehicle makes steering inputs. A servo unit, in particular a hydraulic and/or electric servo unit (also not shown), is advantageously provided between steering wheel and pinion 3 to assist the steering inputs of the operator.

The pinion 3 and the upper and lower shaft extensions 8 and 9 are mounted rotatably in respective upper and lower bearings 10 and 11 in the steering gear housing 2. The bearings 10 and 11 are suitably in the form of sliding and/or rolling bearings, the upper bearing 10 being a fixed bearing and the lower bearing 11 a movable bearing. The fixed bearing 10 supports the pinion 3, or the upper shaft extension 8, substantially rigidly in the radial and axial directions, leaving aside bearing play, whereas the movable bearing 11 supports the lower shaft extension 9 only in the axial direction.

As is apparent from FIG. 1, the lower shaft extension 9 is secured at its axial end below the movable bearing 11 with a nut 12. The nut 12 is accessible for assembly purposes through an opening, closable by means of a closure cap 13, in the lower region of the steering gear housing 2. The closure cap 13 can be, for example, screwed or plugged into the steering gear housing 2.

The movable bearing 11 has, at least in the radial direction, a certain freedom of movement within the steering gear housing 2. This freedom of movement is predefined, for example, by a corresponding slot provided in the steering gear housing 2, in which slot the movable bearing 11 is received displaceably. The longitudinal axis of the slot is advantageously disposed in the drawing plane, in the exemplary embodiment represented in FIG. 1, and perpendicularly to the axis of rotation 4, so that the pinion 3 can be swiveled in the direction of the rack 5, that is, in the radial direction, within the steering gear housing 2. In the lateral direction, that is, perpendicularly to the drawing plane, the movable bearing 11 may be guided, for example, by the side walls of the slot for stable lateral mounting. The fixed bearing 10 may also be in the form of a self-aligning bearing, in order to enable a sufficiently large reciprocating movement of the pinion 3.

As shown in FIG. 1, the movable bearing 11 is spring-loaded by means of a helical spring 14 in the radial direction, that is in the direction not impeded by the movable bearing 11. The helical spring 14 is an elastic spring element. The helical spring 14 may, of course, be replaced by any other elastic spring element, provided it is suitable for preloading the movable bearing 11 in the radial direction not impeded by the bearing 11.

At its end oriented away from the movable bearing 11, the helical spring 14 bears against the steering gear housing 2, or against a tensioning device 15 connected to the steering gear housing 2. In the exemplary embodiment shown in FIG. 1, the tensioning device 15 can be screwed into the steering gear housing 2, so that the spring force with which the helical spring 14 presses against the movable bearing 11 can be simply adjusted by means of the tensioning device 15. Because the tensioning device 15, as shown in FIG. 1, can be screwed into the steering gear housing 2 and is therefore accessible from outside, adjustment of the spring force or preloading force is possible without major complexity or cost even when the rack-type steering gear 1 is installed, for example, in a motor vehicle.

By means of the spring-loaded movable bearing 11 the pinion 3 can be preloaded against the rack 5 so that the toothing 6 of the pinion 3 engages more strongly with the toothing 7 of the rack 5. FIG. 1 shows the pinion 3 in a state in which it is preloaded against the rack 5. As can be seen, in this state the movable bearing 11 does not bear against the steering gear housing 2 in the radial direction on the rack side. At this location the steering gear housing 2 has, for example, a recess 16, or the slot in which the movable bearing 11 is received is so dimensioned that, in the preloaded state, the movable bearing 11 is not in contact with the steering gear housing 2 in the radial direction on the rack side. It is thereby ensured that the preloading force is not limited in an undesired manner by abutment against the steering gear housing, but is freely adjustable. In addition, sufficient freedom of movement for the movable bearing 11, and therefore for the pinion 3, in the radial direction is provided in this way, so that possible wear in the pinion/rack connection is automatically compensated by the spring-loaded movable bearing 11.

The recess 16 may advantageously also be filled with a damping element 17, in particular an elastic or elastomeric damping element, so that the movable bearing 11, and therefore the pinion 3, can bear against the steering gear housing 2 via the damping element 17. This offers the considerable advantage that jolting movements of the pinion 3 caused, for example, by shock loadings, and therefore, in particular, rattle generation by the rack-type steering gear 1, are effectively suppressed. Furthermore, the entire receptacle of the movable bearing 11, for example the inner face of the slot, may also be lined with the damping element 17 in order likewise to damp lateral movements of the pinion 3.

As can be seen in FIG. 1, the rack 5 is mounted in the steering gear housing 2 by means of a linear rolling bearing on the side of the rack body substantially opposite the toothing 7. A pressure piece, as used in the prior art to preload the rack against the pinion, can be omitted in the rack-type steering gear 1 according to the invention, whereby the rack-type steering gear 1 according to the invention has an especially compact and space-saving construction.

Instead of the pressure piece used in the prior art, a linear rolling element track 18 is formed in the rack 5 or in the rack body, as can be seen in FIG. 1. At least one rolling element 19, for example a ball, barrel, cylindrical roller and the like, is guided in the rolling element track 18. Upon axial displacement of the rack 5, the rolling element 19 runs between the rack 5 and the steering gear housing 2. The rolling friction arising in this case is considerably less, for the same preloading force, as compared to a sliding bearing of the rack on a pressure piece generally used according to the prior art. The rack-type steering gear 1 according to the invention therefore imparts a substantially more precise steering feel.

Self-evidently, the rack-type steering gear according to the invention is not limited to theexemplary embodiments described, and shown in the FIGURE. Thus, alternatively to the exemplary embodiment shown in FIG. 1, a plurality of rolling element tracks 18 may be formed in the rack 5, for example around the circumference of the rack 5, each rolling element track 18 receiving and guiding at least one respective rolling element 19. In this way an even more uniform distribution of the force acting in the pinion/rack connection and transmission of said force to the steering gear housing 2 is ensured.

The rolling element track 18 may equally be formed in the steering gear housing 2 or partially both in the rack 5 and in the steering gear housing 2.

In addition, a plurality of rolling elements 19 may, of course, be provided in one track 18. In this case the rolling elements 19 are preferably surrounded by a cage which maintains the rolling elements 19 at a defined distance from one another.

Furthermore, the preloading of the pinion 3 against the rack 5 may also be effected by an eccentric mounting of the pinion 3.

In a preferred configuration, the rack-type steering gear according to the invention is used in a motor vehicle having an electrically and/or hydraulically driven power-assisted steering system.

### LIST OF REFERENCES

1 Rack-type steering gear

2 Steering gear housing

3 Pinion

4 Axis of rotation of 3

5 Rack

6 Toothing of 3

7 Toothing of 5

8 Upper shaft extension of 3

9 Lower shaft extension of 3

10 Upper bearing, fixed bearing

11 Lower bearing, movable bearing

12 Nut

13 Closure cap

14 Helical spring

15 Tensioning device

16 Recess

17 Damping element

18 Linear rolling element track

19 Rolling element

1. A rack-type steering gear (1), comprising a steering gear housing (2), a pinion (3) connected non-rotatably to a steering shaft and mounted rotatably in the steering gear housing (2), and a rack (5) mounted axially displaceably in the steering gear housing (2), the toothing of the pinion (3) engaging with the toothing of the rack (5),
wherein
the pinion (3) can be preloaded against the rack (5) and the rack (5) is mounted in the steering gear housing (2) by means of linear rolling bearings.

2. The rack-type steering gear (1) as claimed in claim 1,
wherein
at least one linear rolling element track (18) is formed in the rack (5) and/or in the steering gear housing (2) in order to guide at least one rolling element (19).

3. The rack-type steering gear (1) as claimed in claim 1,
wherein
the pinion (3) can be preloaded elastically against the rack (5) by means of at least one spring element (14).

4. The rack-type steering gear (1) as claimed in claim 1,
wherein
the pinion (3) can bear against the steering gear housing (2) by means of at least one damping element (17).

5. The rack-type steering gear (1) as claimed in claim 1,
wherein
a preloading force is adjustable by means of at least one tensioning device (15).

6. The rack-type steering gear (1) as claimed in claim 1,
wherein
the pinion (3) is mounted by means of a fixed bearing (10) and at least one movable bearing (11) in such a manner that the pinion (3) can be swiveled in a radial direction.

7. The rack-type steering gear (1) as claimed in claim 6,
wherein
the movable bearing (11) is spring-loaded in a radial direction by means of at least one spring element (14).

8. The rack-type steering gear (1) as claimed in claim 6,
wherein
the movable bearing (11) bears against the steering gear housing (2) by means of at least one damping element (17).

9. The rack-type steering gear (1) as claimed in claim 2,
wherein
the pinion (3) can be preloaded elastically against the rack (5) by means of at least one spring element (14).

10. The rack-type steering gear (1) as claimed in claim 7,
wherein
the movable bearing (11) bears against the steering gear housing (2) by means of at least one damping element (17).
